(19) United States
(12) Patent Application Publication
(10) Pub. No.: US 2006/0245868 A1
(43) Pub. Date: Nov. 2, 2006

(54) Stacking device, especially for mattresses

(75) Inventors: Erich Rudolf, Viernheim (DE); Axel Stoll, Hohen-Sulzen (DE)

Correspondence Address: STAAS & HALSEY LLP, SUITE 700, 1201 NEW YORK AVENUE, N.W., WASHINGTON, DC, 20005, US

(73) Assignee: Fillmatic Polsterindustrie-Maschinen GmbH, Mannheim (DE)

(21) Appl. No.: 11/034,201

(22) Filed: Jan. 13, 2005

(30) Foreign Application Priority Data
Jan. 15, 2004 (EP) 04 000789

(51) Int. Cl. B65G 67/00

(52) U.S. Cl. 414/401

(57) ABSTRACT

A stacking device for loads, especially for taking flat lying mattresses from one level and delivering them to a different level. The device has a vertically movable lifting platform between spaced pillars, and a mechanism for moving the lifting platform. Weights are provided at the pillars to pull the lifting platform upwards therealong. At least one transfer belt is provided at the lifting platform between the two pillars and is connected to a driver pulling the lifting platform via the transfer belt vertically downwards.

The present invention relates to a stacking device for loads, especially for mattresses, with the features of the preamble of claim 1.

It is hard work to pile wrapped mattresses on each other and it is linked to high stresses of the back doing so manually. It is known to combine devices for wrapping of mattresses with stacking devices. The stacking devices take over the flat lying mattresses on a lifting platform, drive them vertically to the top of a stack and subsequently push the mattress from the lifting platform in such a way that the mattress is lying on the stack. Slow stacking devices are lifting the platform by means of a mechanism with lifting claws. Faster stacking devices are lifting the platform by ropes or chains. The stacking devices have to be accessible for the staff at the side where the mattresses are piled in order to exchange full palets against empty ones. Security matters in this context. It has to be avoided that persons are under the lifting platform where they risk being squashed when the lifting platform is coming down. Flexible security covers of the shutters type known from machine tools are expensive. Security grids with access locks surrounding the stacking devices are an obstacle to the exchange of the stacks and they are expensive too.

The object of the present invention is to achieve a low cost and safe stacking device for loads, especially for mattresses, with freely accessible stacks.

The invention is achieved with a stacking device for loads, especially for mattresses, with the features of claim 1.

According to the invention a stacking devices for loads, especially for taking flat lying mattresses from one level and delivery of the flat lying mattresses to a different level, is provided with a vertically movable lifting platform, being held by pillars standing apart from each other. Weights are provided at the pillars being connected to the lifting platform via a chain or rope mechanism in such a way that the weights are pulling the lifting platform upwards with the weights being all together heavier than the lifting platform with the load. The lifting platform is provided with at least one transfer belt bridging the distance between two pillars and being connected to drive means pulling the lifting platform via the transfer belt vertically downwards. As advantage of the stacking device according to the invention results that its inner space is protected against access by the transfer belt already during construction allowing people to approach to the stacking device right next to the transfer belt without danger thus avoiding the need for the provision of safety grids around the stacking devices. The chain- or rope lifting mechanism of the stacking device according to the invention is constantly tensed during use, on one hand by the lifting platform and on the other hand by the weights at the pillars thus not being exposed to any changes of load excluding one reason for wear. At failure of the drive means the weights are pulling the lifting platform of the stacking device according to the invention upwards and thus away from a possibly endangering position till the weights are standing on the floor. The compact concept of the stacking device according to the invention allows its transport in a standard container up to a certain working width.

According to a preferred embodiment of the invention the lifting platform is essentially rectangular with pillars being provided at the respective corners of the lifting platform. Pillars of the stacking device according to the invention are preferably positioned in couples in front of a stack of mattresses and the transfer belt is covering one entire side of the lifting platform between two pillars with the side corresponding at least to the width of the stack of mattresses safeguarding by the transfer belt the access between the stack of mattresses and an entire side of the lifting platform.

According to another preferred embodiment of the invention there are provided two transfer belts at the vertically movable lifting platform of the stacking device according to the invention in order to safeguard the access to two sides of the lifting platform.

According to another preferred embodiment of the invention the two transfer belts are opposed at the lifting platform for symmetrical driving conditions of the stacking device according to the invention.

According to another preferred embodiment of the invention there are preferably provided two opposed rolls at the periphery of the vertically movable lifting platform for winding up of the transfer belts. The inner space of the stacking device according to the invention is protected behind the transfer belts at any level of the stack and over at least one width of one mattress. The stack can be generated without any risk creating interstice towards the stacking device according to the invention being capable to support the stack by means of the transfer belt running over the rolls. During operation of the stacking device according to the invention

the roll under the transfer belt is rolling up and down along the mattresses of the adjacent stack thus—by rolling up and down of the roll—adjusting it by pushing back mattresses extending towards the stacking device.

According to another preferred embodiment of the invention the weights are heavier than the lifting platform plus one mattress and one person. The transfer belts with increased tension reliably prevent any intrusion of human bodies from the side into the transfer belts under the rolls of the stacking device according to the invention for increased safety.

According to another preferred embodiment of the invention one section of the surface of the lifting platform is pivotable in such a way that a mattress being pushed only partly onto the lifting platform will skid by its own weight onto the pivoted plate in the lifting platform. To provide for reliably sliding mattresses in a non-skid foil there are arranged air escape means in the surface of the pivoting plate allowing improved gliding of the mattress on an air cushion.

According to another preferred embodiment of the invention there is provided above the lifting platform a horizontally movable pushing unit for removing the mattress of the lifting platform onto the stack of the stacking device according to the invention. The existence of this pushing unit is causing for safety reasons that no rolling track is used for introduction but a smooth surface from the pivoting plate to the lifting platform. A hand put in between rolls of a rolling track would be squashed from the pushing unit against the longitudinal bar of the rolling track to which the rolls are mounted. On the smooth surface of the pivoting plate the pushing unit moves the hand or any other part of the body of a person simply aside without causing any harm.

The invention will be described by the aid of a preferred embodiment example by referring to the attached drawing, in which:

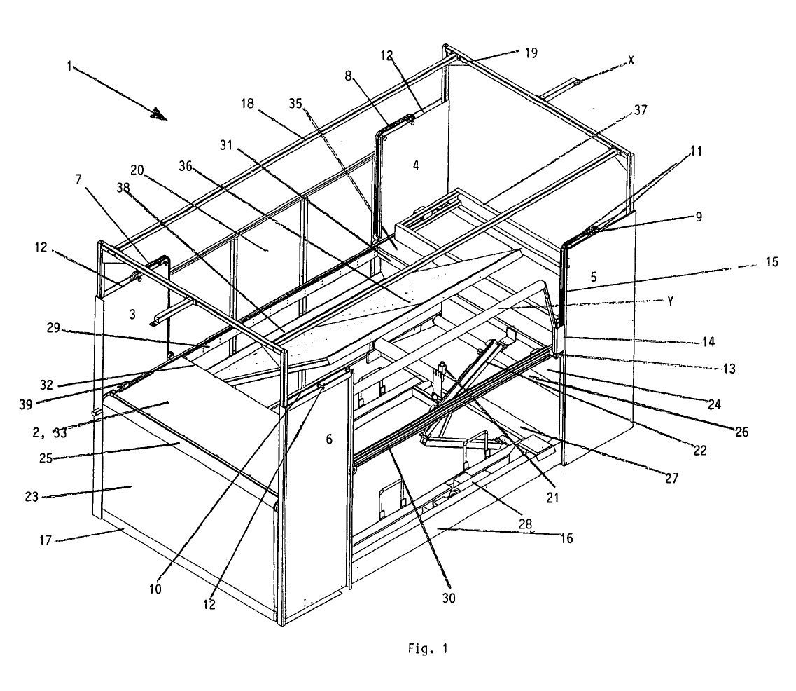

FIG. 1: shows a schematic view of a stacking device according to the invention.

FIG. 1: A stacking device 1 for reception of flat lying mattresses (not presented) from one level for delivery of the flat lying mattresses to another level is provided with a vertically movable rectangular lifting platform 2 at four pillars 3, 4, 5, 6 at the corners of the lifting platform 2. Chains or ropes 7, 8, 9, 10 of a lifting mechanism for the lifting platform 2 are connected in such a way via deviation rolls 11 at the respective upper edge 12 of the four pillars 3, 4, 5, 6 on one hand and via deviation rolls 13 in guiding means 14 at the respective lateral edge 15 of the four pillars 3, 4, 5, 6 to the lifting platform 2 on the other hand that the weights are pulling the lifting platform 2 upwards relative to the four pillars 3, 4, 5, 6 as well if loaded with a mattress because the weights are heavier than the lifting platform 2 plus the load of one mattress.

The pillars 3, 4, 5, 6 are held by lower longitudinal struts 16 and transversal struts 17 and an upper frame 18 being reinforced with stiffening angels 19. Between the pillars 3, 4 is provided a covering of door elements 20 from the floor till close to the upper edge 12 of the pillars 3, 4. An altimeter “x” on both sides captures the height of a stack. Pivoting of the pivoting plate is effected by two stoppers 21 by lowering the rotation point of the pivoting plate along the frame of the lifting platform deeper than the level of stopper 21. Electric wiring is guided in a claw element 22 from the bottom to the vertically movable lifting platform 2 of the stacking device 1.

Opposed transfer belts 23, 24 are provided at the lifting platform 2 entirely covering respectively the distance of at least one width of a matress between the two pillars 6, 3 and the two pillars 4, 5. Deviating shafts 25 and 26 are provided at the frontal sides of the stacking table and the stacking device 1 at the bottom between the two pillars 6, 3 and the two pillars 4, 5 for deviation of the transfer belts 23, 24 towards drive shafts 27 connected via a chain- or beltdrive (not presented) with a electromotor drive 28 engaging the drive shafts 27 rotatably for winding up the transfer belts 23, 24 and thus vertically pulling down the lifting platform 2 along the rolls 25 with the transfer belts 23, 24.

Lifting platform 2 is held in a frame of longitudinal bars 29, 30 and transversal bars 31, 32 and is provided with a front plate 33 and a rear plate 35 with in between a planar pivoting element 36, i.e. the pivoting plate of lifting platform 2, pivotable around an axle parallel to the longitudinal bars 29, 30 and supported in the transversal bars 31, 32 with the axle being closer to the longitudinal bar 30 than to the longitudinal bar 29. The length of the planar pivoting element 36 corresponds essentially to the distance of the two pillars 6, 3 towards each other.

A horizontally driven pushing unit 37 is provided above the lifting platform 2 being movable from the rear plate 35 till the front plate 33. Pushing unit 37 is driven by an electromotor drive (not presented) via tension elements 39 guided in the longitudinal bars 29, 30 of the lifting platform 2. Pushing unit 37 is capable of moving only when the pivoting plate is positioned horizontally.

Carrying elements of the stacking device are made from metal, e.g. steel or aluminium and planar elements are made from synthetic material. The transfer belts 23, 24 are made from textile tissue.

Procedure for Operation of the Stacking Device 1

Lifting platform 2 of the stacking device 1 before start of operation is in its lowest position and the pivoting plate is folded up.

Flat lying mattresses are delivered from a wrapping machine for mattresses (not presented) between the two pillars 6, 3 on a defined level. A pushing roll “Y” bridges the gap created by folding up of the pivoting plate: thus particularly soft mattresses, e.g. from latex are prevented from diving underneath the pivoting plate.

The electromotor drive 28 rotationally drives the drive shafts 27 to unwind the transfer belts 23, 24 and thus the lifting platform 2 is pulled up through the effect of the weights in the pillars 3, 4, 5, 6 till the upper edge of the stack of already deposited mattresses is reached while the pivoting plate 36 is pivoted downwards with its side turned towards the wrapping machine for mattresses and the mattress in a way that the lifting platform 2 is provided with an overall smooth surface out of pivoting plate 36 and the front and rear plates 33 and 35.

Pushing unit 37 pushes the mattress across the front plate 33 and roll 25 onto the stack und returns in its starting position above the rear plate 35. Pushing unit 37 is in its starting position above the plate 33 for stacking onto the other stacking place and pushes out across plate 35.

By winding up of the belts 23 and 24 the empty stacking device 1 is pulling downwards the lifting platform 2 against the weight of the counterweights in the pillars 3, 4, 5, 6 for reception of the next mattress in the way outlined above.

Rolls 25 together with the belts 23 and 24 are adjusting protruding mattresses by rolling up and down at the stack developing right next.

1. A stacking device (1) for loads, especially for taking flat lying mattresses from one level and delivering the flat lying mattresses to a different level, provided with a vertically movable lifting platform (2) at at least three pillars (3, 4, 5, 6) standing apart from each other and a chain or rope mechanism (7, 8, 9, 10) for the lifting platform, characterized in that weights are provided at the pillars (3, 4, 5, 6) being connected to the lifting platform (2) in a way that the weights are pulling the lifting platform (2) upwards along the pillars (3, 4, 5, 6) with the weights being heavier than the lifting platform (2) with the load and at least one transfer belt (23, 24) is provided at the lifting platform (2) bridging the distance between two pillars (3, 4, 5, 6) and being connected to drive means (28) pulling the lifting platform (2) via the transfer belt (23, 24) vertically downwards.

2. A stacking device (1) according to claim 1 characterized in that the lifting platform (2) is essentially rectangular with four pillars (3, 4, 5, 6) being provided at the respective corners of the lifting platform (2).

3. A stacking device (1) according to claim 1 characterized in that there are provided two transfer belts (23, 24) at the lifting platform (2).

4. A stacking device (1) according to claim 3 characterized in that the two transfer belts (23, 24) are opposed at the lifting platform (2).

5. A stacking device (1) according to claim 1 characterized in that there are preferably provided two opposed rolls (25) at the periphery of the lifting platform (2) for winding up of the transfer belts (23, 24).

6. A stacking device (1) according to claim 1 characterized in that there is provided a drive shaft (27) below the lifting platform (2) for winding up of the transfer belts (23, 24).

7. A stacking device (1) according to claim 1 characterized in that the weights are heavier than the lifting platform (2) plus one mattress and one person.

8. A stacking device (1) according to claim 1 characterized in that a pivotable element (36) of the lifting platform (2) is pivotable.

9. A stacking device (1) according to claim 1 characterized in that one section of the lifting platform (2) is effecting the intrusion of the loads by rolls arranged transversely to the direction of expel.

10. A stacking device (1) according to claim 1 characterized in that a horizontally movable pushing unit (37) is provided above the lifting platform (2).
